(19) United States
(12) Patent Application Publication
(10) Pub. No.: US 2010/0271841 A1
(43) Pub. Date: Oct. 28, 2010

(54) LED Lighting With Light Guide Plate Having Side Reflector

(75) Inventor: Steven KIM, Riverdale, NJ (US)

Correspondence Address: HOLLAND & KNIGHT LLP, 2099 PENNSYLVANIA AVE, SUITE 100, WASHINGTON, DC, 20006, US

(73) Assignee: LED FOLIO CORPORATION, Riverdale, NJ (US)

(21) Appl. No.: 12/430,688

(22) Filed: Apr. 27, 2009

(51) Int. Cl. F21V 7/04

(52) U.S. Cl. 362/607

(57) ABSTRACT

A light guide plate having a top surface through which light is emitted, a bottom surface opposite to the top surface and a side surface between the top and bottom surfaces, a bottom reflector on the bottom surface for reflecting light at the bottom surface back into the light guide plate, light emitting diodes at the side surface and a side reflector on the side surface for reflecting light at the side surface back into the light guide plate, wherein the side reflector on the side surface has an opening corresponding to at least one of the light emitting diodes

### BACKGROUND OF THE INVENTION

1. Field of the Invention

The embodiments of the invention relate to Light Emitting Diode (LED) lighting, and more particularly, to a LED lighting with a light guide plate having a side reflector. Although embodiments of the invention are suitable for a wide scope of applications, it is particularly suitable for increasing the light redirection efficiency of a light guide plate receiving light from a light emitting diode.

2. Discussion of the Related Art

In general, LED lighting is either a direct type or a dispersion type. The direct type of LED lighting has light emitting diodes that emit light directly through a lens or directly through a diffuser. The dispersion type of LED lighting has light emitting diodes that emit light into a waveguide, which redirects and disperses the light. Although a diffuser can minimize the harshness of the light from a direct type of LED lighting, the dispersed light from a dispersion type of LED lighting is easier on the eyes.

FIG. 1a is an exploded perspective of dispersion type LED lighting according to the prior art. As shown in FIG. 1, the LED lighting 100 according to the prior art includes a light guide plate 101, LEDs 110 on first and second light strips 121 and 122, a bottom reflector 130 and side reflectors 131-134 that surround the light guide plate 101. The light guide plate 101 has a top surface 101a through which light is emitted, side surfaces 101b-101e through which light can be emitted or received, and bottom surface 101f at which light is reflected by the bottom reflector 130. The LEDs 110 on first and second light strips 121 and 122 emit light into two opposing side surfaces 101b and 101d of the light guide plate 101. The side reflectors 131-134 surrounding the light guide plate 101 reflect light from the side surfaces 101b-101e back into the side surfaces 101b-101e, respectively. The first and second light strips 121 and 122 have a reflective capability to also reflect light from the side surfaces 101b-101e back into the side surfaces 101b-101e, respectively.

FIG. 1b is an assembled perspective view of the prior art. FIG. 1c is a cross-sectional view along the line I-I′ of the assembled perspective view shown in FIG. 1b. As shown in FIGS. 1b and 1c, the side reflectors 131-134 cover a peripheral portion of the top surface 101a when the LED lighting 100 is assembled. Such a covering of the top surface 101a reduces the light output from the LED lighting 100.

As also shown in FIG. 1c, the reflected light L1 is light from a side surface 101b that is reflected by the side reflector 131 back into the side surface 101b of the light guide plate 101. However, light from the side surface that is reflected many times by the side-reflector, such as reflected light L2, is not as bright as the reflected light L1. Light reflected off of the light strip, such as reflected light L3, or reflected off both of the light strip and the side reflector, such as reflected light L4, has even further reduced brightness than the reflected light L1, which is light reflected directly back into a side surface by a side reflector. Such reductions in the brightness of reflected light decreases the light redirection efficiency because light, which initially came from the LEDs 110, is lost and can not be redirected through the top surface 101a of the light guide plate 101.

### SUMMARY OF THE INVENTION

Accordingly, embodiments of the invention are directed to a LED lighting with a light guide plate having a side reflector that substantially obviates one or more of the problems due to limitations and disadvantages of the related art.

An object of embodiments of the invention is to provide a side reflector for light guide plate of LED lighting that prevents light loss.

Another object of embodiments of the invention is to provide a side reflector for light guide plate of LED that increases the light redirection efficiency.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the LED lighting includes a light guide plate having a top surface through which light is emitted, a bottom surface opposite to the top surface and a side surface between the top and bottom surfaces, a bottom reflector on the bottom surface for reflecting light at the bottom surface back into the light guide plate, light emitting diodes at the side surface and a side reflector on the side surface for reflecting light at the side surface back into the light guide plate, wherein the side reflector on the side surface has an opening corresponding to at least one of the light emitting diodes.

In another aspect, the LED lighting includes a light guide plate having a top surface through which light is emitted, a bottom surface opposite to the top surface and side surfaces between the top and bottom surfaces, a bottom reflector on the bottom surface for reflecting light at the bottom surface back into the light guide plate, a light strip having a plurality of light emitting diodes at least at one of the side surfaces, side reflectors on each of the side surfaces for reflecting light at the side surfaces back into the light guide plate, wherein a side reflector on the at least one of the side surfaces is positioned between the light guide plate and the light strip, and has an opening corresponding to at least one of the plurality of light emitting diodes.

In yet another aspect, the LED lighting includes a light guide plate having a top surface through which light is emitted, a bottom surface opposite to the top surface and side surfaces between the top and bottom surfaces, a bottom reflector on the bottom surface for reflecting light at the bottom surface back into the light guide plate, first and second pluralities of light emitting diodes respectively at opposing side surfaces, and side reflectors on each of the side surfaces for reflecting light at the side surfaces back into the light guide plate, wherein side reflectors at the opposing side surfaces each have at least an opening corresponding to at least one of the first and second pluralities of light emitting diodes.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1a is an exploded perspective of dispersion type LED lighting according to the prior art.

FIG. 1b is an assembled perspective view of the prior art.

FIG. 1c is a cross-sectional view along the line I-I′ of the assembled perspective view shown in FIG. 1b.

FIG. 2a is an exploded perspective view of a first exemplary embodiment of the invention.

FIG. 2b is an assembled perspective view of the first exemplary embodiment of the invention.

FIG. 3a is an exploded perspective view of a second exemplary embodiment of the invention.

FIG. 3b is an assembled perspective view of the second exemplary embodiment of the invention.

FIG. 4a is an exploded perspective view of a third exemplary embodiment of the invention.

FIG. 4b is an assembled perspective view of the third exemplary embodiment of the invention.

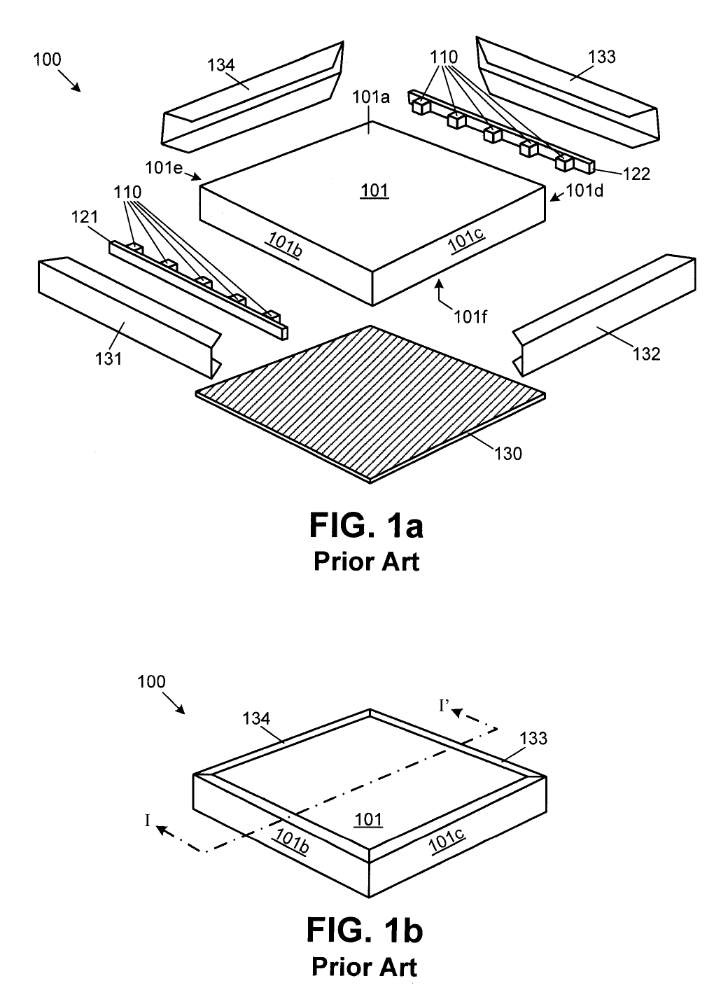

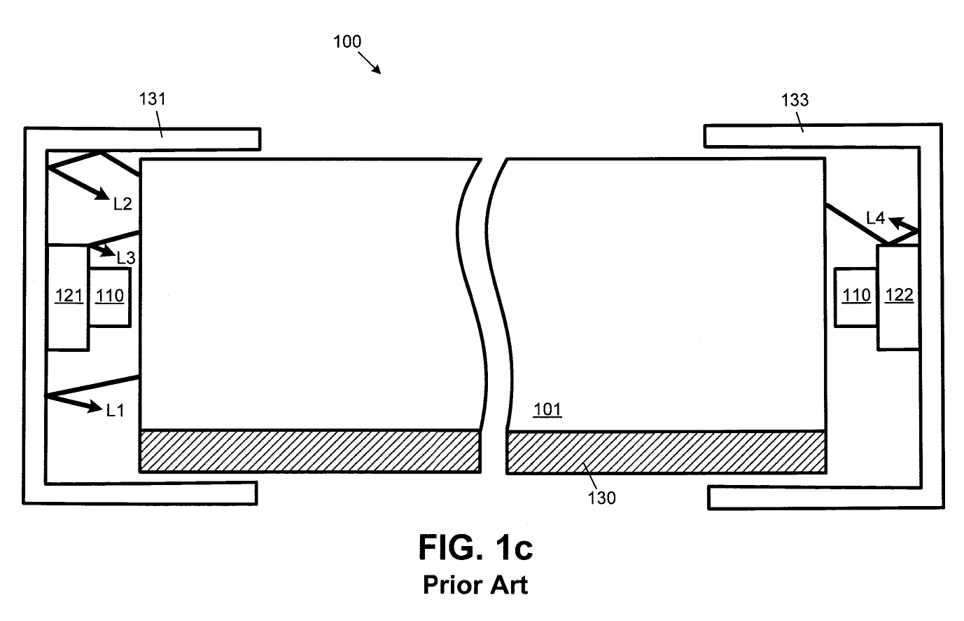

### DETAILED DESCRIPTION OF THE PREFERRED EMBODIMENTS

Reference will now be made in detail to the preferred embodiments of the invention, examples of which are illustrated in the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

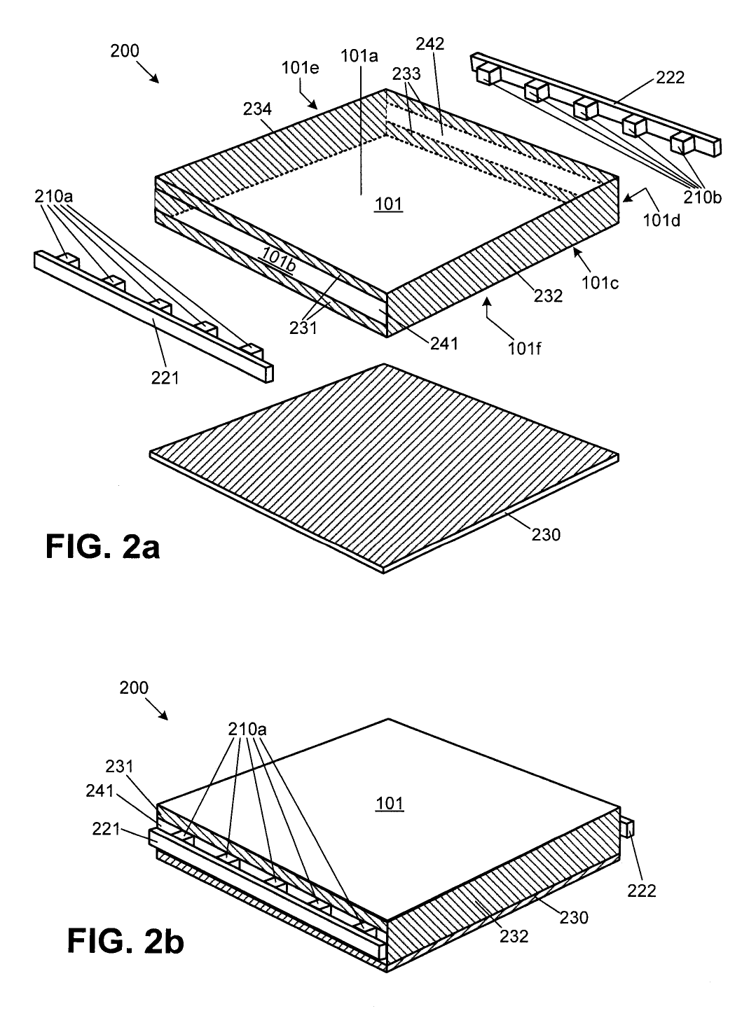

FIG. 2a is an exploded perspective view of a first exemplary embodiment of the invention. As shown in FIG. 2a, the LED lighting 200 according to the first exemplary embodiment includes a light guide plate 101, LEDs 210a and 210b on first and second light strips 221 and 222, a bottom reflector 230 and side reflectors 231-234 on the sides of the light guide plate 101. The light guide plate 101 has a top surface 101a through which light is emitted, side surfaces 101b-101e at which light is reflected by the side reflectors 231-234, and bottom surface 101f at which light is reflected by the bottom reflector 230. The top surface 101a opposes the bottom surface 101f and the side surfaces 101b-101e are located between the top surface 101a and the bottom surface 101f. The LEDs 210a and 210b on first and second light strips 221 and 222 emit light into two opposing side surfaces 101b and 101d of the light guide plate 101. The side reflectors 231-234 are positioned on each of the side surfaces 101b-101e so as to reflect light at the side surfaces back into the light guide plate 101.

The side reflectors 232 and 234 on side surfaces 101b and 101d cover all of side surfaces 101b and 101d. The side reflectors 231 and 233 on side surfaces 101b and 101d have slit openings 241 and 242, respectively. The slit opening 241 corresponds to LEDs 210a on the first light strip 221. The slit opening 242 corresponds to LEDs 210b on the second light strip 222. The side reflector 231 is positioned between side surfaces 101b and the first light strip 221. The side reflector 233 is positioned between side surfaces 101d and the second light strip 222.

The side reflector 231 on side surface 101b reflects light, which travels directly across the light guide plate 101 from the LEDs 210b on the second light strip 222, back into the light guide plate 101. The side reflector 233 on side surface 101d reflects light, which travels directly across the light guide plate 101 from the LEDs 210a on the first light strip 221, back into the light guide plate 101. By reflecting light that travels directly across the light guide plate 101 from the LEDs 210a and 210b at the side surfaces 101b and 101d through which light is received from the LEDs 210a and 210b, the light redirection efficiency is improved.

The side reflectors 231-234 in the first exemplary embodiment shown in FIG. 2a are coated onto the light guide plate 101. For example, the side reflectors 231-234 can be a painted layer applied using a paint sprayer. In another example, the side reflectors 231-234 can be a deposited layer applied using chemical vapor deposition, plasma deposition or some other type of deposition process that can deposit a metallic layer.

A mask can be used for the slit openings 241, and the top and bottom surfaces 101a and 101f of the light guide plate 101 during the coating process for the side reflectors 231-234. In that alternative, the bottom surface 101f can also be coated so as to alleviate the need for a separate bottom reflector 130. The masking defines the slit openings and prevents any coating of side reflector material onto the top surface 101a of the light guide plate 101. By providing the side reflectors on the side surfaces 101b-101d such that side reflectors do not overlap onto the top surface 101a of the light guide plate 101, light loss is prevented in the LED lighting 200.

FIG. 2b is an assembled perspective view of the first exemplary embodiment of the invention. As shown in FIG. 2b, LEDs 210a on the first light strip 221 can be positioned within the slit opening 241 of the side reflector 231. Further, the LEDs 210a on the first light strip 221 can be adhesively attached to side surface 101b of the light guide plate 101. The LEDs 210b on the second light strip 222 can be positioned within the slit opening 242 of the side reflector 233. Further, the LEDs 210 on the second light strip 222 can be adhesively attached to side surface 101d of the light guide plate 101.

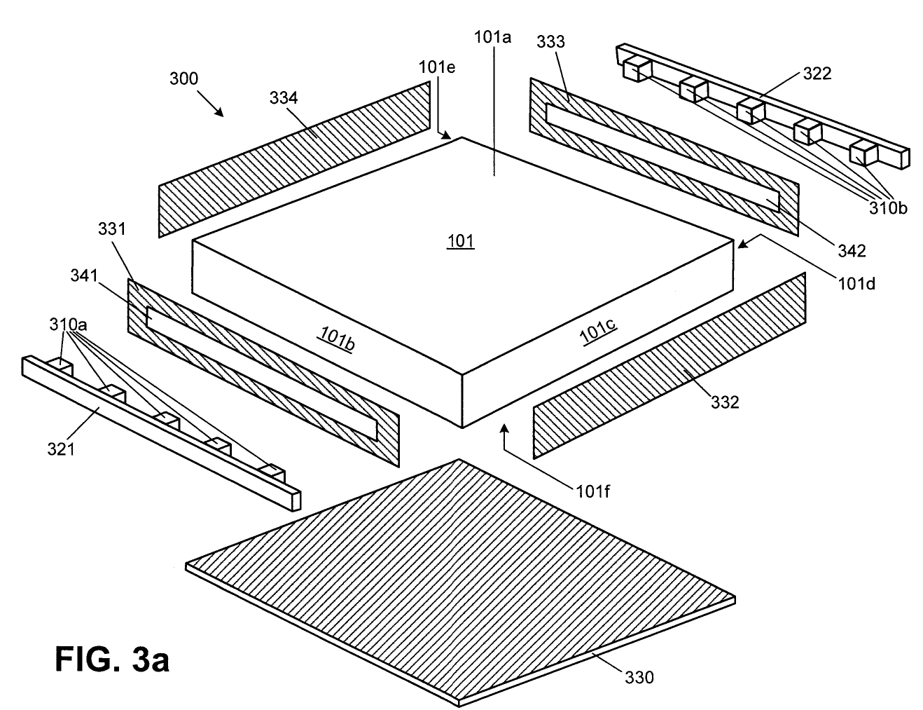

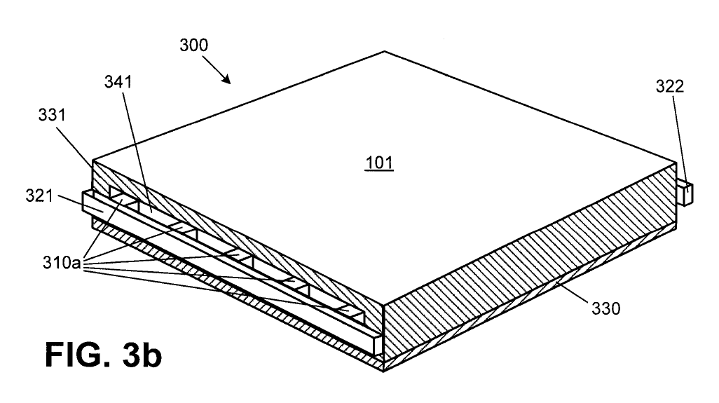

FIG. 3a is an exploded perspective view of a second exemplary embodiment of the invention. As shown in FIG. 3a, the LED lighting 300 according to the second exemplary embodiment includes a light guide plate 101, LEDs 310a and 310b on first and second light strips 321 and 322, a bottom reflector 330 and side reflectors 331-334 that are adhesively bonded to the sides of the light guide plate 101. The light guide plate 101 has a top surface 101a through which light is emitted, side surfaces 101b-101e at which is reflected by the side reflectors 331-334, and bottom surface 101f at which light is reflected by the bottom reflector 330. The top surface 101a opposes the bottom surface 101f and the side surfaces 101b-101e are located between the top surface 101a and the bottom surface 101f. The LEDs 310a and 310b on first and second light strips 321 and 322 emit light into two opposing side surfaces 101b and 101d of the light guide plate 101. The side reflectors 331-334 are adhered onto each of the side surfaces 101b-101e so as to reflect light at the side surfaces back into the light guide plate 101.

The side reflectors 332 and 334 on side surfaces 101b and 101d cover all of side surfaces 101b and 101d. The side reflectors 331 and 333 on side surfaces 101b and 101d each have single aperture openings 341 and 342, respectively. The single aperture opening 341 corresponds to LEDs 310a on the first light strip 321. The single aperture opening 342 corresponds to LEDs 310b on the second light strip 322. The side reflector 331 is positioned between side surfaces 101b and the first light strip 321. The side reflector 333 is positioned between side surfaces 110d and the second light strip 322.

The side reflector 331 on side surface 101b reflects light, which travels directly across the light guide plate 101 from the LEDs 310b on the second light strip 322, back into the light guide plate 101. The side reflector 333 on side surface 110d reflects light, which travels directly across the light guide plate 101 from the LEDs 310a on the first light strip 321, back into the light guide plate 101. A side reflector having a single aperture opening reflects more light directly into the light guide plate 101 at the side surface than a side reflector having a slit opening, as described in the first embodiment, because of the increased surface area of such a side reflector at ends of the side reflector. By reflecting light that travels directly across the light guide plate 101 from the LEDs 310a and 310b at the side surfaces 101d and 101b through which light is received from the LEDs 310b and 310a, the light redirection efficiency is improved.

The side reflectors 331-334 in the second exemplary embodiment shown in FIG. 3a are adhesively applied onto the light guide plate 101. For example, the side reflectors without openings can be stickers while the side reflectors with openings can be backed stickers such that a sticker with an opening can be applied correctly to a side surface and then the backing is removed. The edges of such stickers can be trimmed so that the stickers are only on the side surfaces of the light guide plate. In another example, the side reflectors 331-334 can be a tape applied to the side surfaces with the edges of the tape being trimmed so that the tape is only on the side surfaces and the openings are then cut out from the tape. By providing the side reflectors on the side surfaces 101b-101d such that side reflectors do not overlap onto the top surface 101a of the light guide plate 101, light loss is prevented in the LED lighting 300.

FIG. 3b is an assembled perspective view of the second exemplary embodiment of the invention. As shown in FIG. 3b, LEDs 310a on the first light strip 321 can be positioned within the single aperture opening 341 of the side reflector 331. Further, the LEDs 310a on the first light strip 321 can be adhesively attached to side surface 101b of the light guide plate 101. The LEDs 310b on the second light strip 322 can be positioned within the single aperture opening 342 of the side reflector 333. Further, the LEDs 310b on the second light strip 322 can be adhesively attached to side surface 101d of the light guide plate 101. In the alternative, the openings in the side reflectors 331 and 333 can be strip openings, such as described in the first embodiment, to simplify alignment of the LEDs to the openings in the side reflectors but the light redirection efficiency of the lighting device will be slightly decreased.

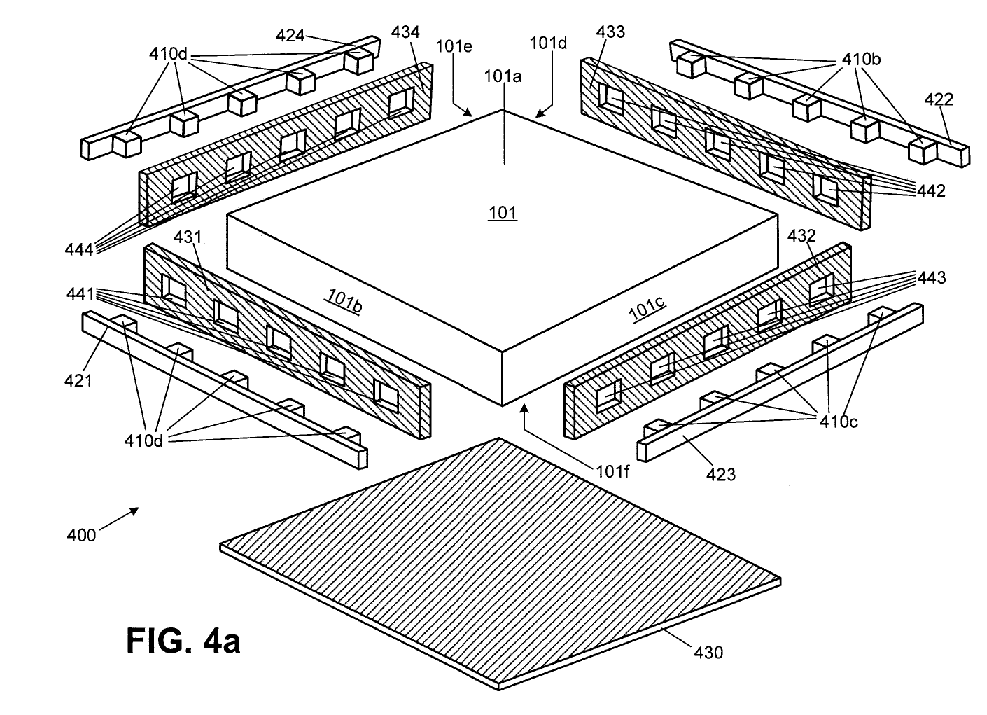

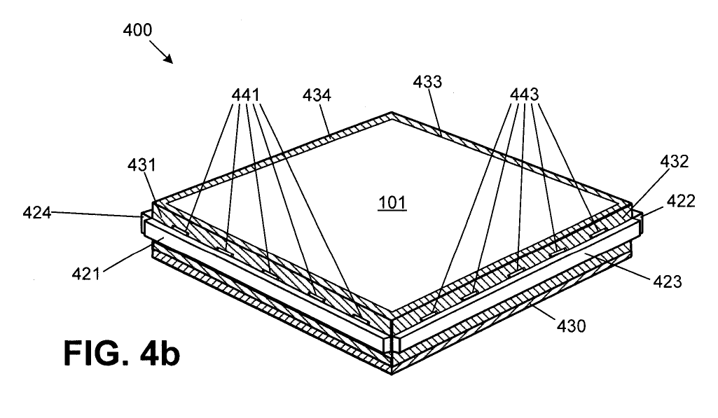

FIG. 4a is an exploded perspective view of a third exemplary embodiment of the invention. As shown in FIG. 4a, the LED lighting 400 according to the third exemplary embodiment includes a light guide plate 101, LEDs 410a-410d on first, second, third and fourth light strips 421-424, a bottom reflector 430 and side reflectors 431-434 that are adhesively bonded to the sides of the light guide plate 101. The light guide plate 101 has a top surface 101a through which light is emitted, side surfaces 101b-101e at which is reflected by the side reflectors 431-434, and bottom surface 101f at which light is reflected by the bottom reflector 430. The top surface 101a opposes the bottom surface 101f and the side surfaces 101b-101e are located between the top surface 101a and the bottom surface 101f. The LEDs 410a and 410b on first and second light strips 421 and 422 emit light into two opposing side surfaces 101b and 101d of the light guide plate 101. The LEDs 410c and 410d on third and fourth light strips 423 and 424 emit light into two other opposing side surfaces 101c and 101e of the light guide plate 101. The side reflectors 431-434 are adhered onto each of the side surfaces 101b-101e so as to reflect light at the side surfaces back into the light guide plate 101.

The side reflectors 431-434 on side surfaces 101b-101e have aperture openings 441-444, respectively. The aperture openings 441 respectively correspond to LEDs 410a on the first light strip 421. The aperture openings 442 respectively correspond to LEDs 410b on the second light strip 422. The aperture openings 443 respectively correspond to LEDs 410c on the third light strip 423. The aperture openings 444 respectively correspond to LEDs 410d on the fourth light strip 424. The side reflector 431 is positioned between side surfaces 101b and the first light strip 421. The side reflector 432 is positioned between side surfaces 101c and the third light strip 423. The side reflector 433 is positioned between side surfaces 101d and the second light strip 422. The side reflector 434 is positioned between side surfaces 101e and the fourth light strip 424.

The first side reflector 431 on side surface 101b reflects light, which travels directly across the light guide plate 101 from the LEDs 410b on the second light strip 422, back into the light guide plate 101. The second side reflector 433 on side surface 101d reflects light, which travels directly across the light guide plate 101 from the LEDs 410a on the first light strip 421, back into the light guide plate 101. The third side reflector 432 on side surface 101c reflects light, which travels directly across the light guide plate 101 from the LEDs 410d on the fourth light strip 424, back into the light guide plate 101. The fourth side reflector 434 on side surface 101e reflects light, which travels directly across the light guide plate 101 from the LEDs 410c on the third light strip 423, back into the light guide plate 101. A side reflector having respective aperture openings for each of the LEDs reflects more light directly into the light guide plate at the side surfaces than a side reflector having a slit opening, as described in the first embodiment, or a side reflector having a single aperture, as described in the second embodiment, because of the increased surface area of such a side reflector at ends of the side reflector and in between the LEDs. By reflecting light that travels directly across the light guide plate 101 from the LEDs 410a, 410b, 410c and 410 at the side surfaces 101d, 101b, 101e and 101 through which light is received from the LEDs 410b, 410a, 410d and 410c, the light redirection efficiency is improved.

The side reflectors 431-434 in the third exemplary embodiment shown in FIG. 4a are adhesively applied onto the light guide plate 101. For example, the side reflectors can be painted, metalized or metallic templates that each have a plurality of apertures. The base material of the template can be a fibrous material, an elastomer, a plastic or a metal. An example of a fibrous material is cardboard or cardstock. An example of an elastomer is silicone, rubber or foam. The size of such templates matches or is slightly less than the side surfaces of the light guide plate while the thickness of such templates is larger or the same as the distance at which the LEDs protrude from the light strips. By providing the side reflectors only on the side surfaces 101b-101d of the light guide plate 101 such that side reflectors do not overlap onto the top surface 101a of the light guide plate 101, light loss is prevented in the LED lighting 400.

FIG. 4b is an assembled perspective view of the third exemplary embodiment of the invention. As shown in FIG. 4b, LEDs 410a on the first light strip 421 are respectively positioned within the aperture openings 441 of the first side reflector 431. LEDs on the third light strip 423 can be respectively positioned within the aperture openings 443 of the second side reflector 432. Further, LEDs on the second light strip 422 can be respectively positioned within the aperture openings of a third side reflector 433 and LEDs on the fourth light strip 424 can be respectively positioned within the aperture openings of the fourth side reflector 434.

The LEDs can be adhesively attached to the side reflectors. In the alternative, the light strips can be adhesively attached to the side reflectors. In yet another alternative, both the LEDs and the light strips are adhesively attached to the side reflectors.

The openings in the side reflectors can be strip openings, such as described in the first embodiment, or a single aperture opening, such as described in the second embodiment, to simplify alignment of the LEDs to the openings in the side reflectors but the light redirection efficiency of the light device will be decreased. Although rectangular lighting devices are shown in the first, second and third embodiments, the lighting devices according to embodiments of the invention can have any polygonal shape, curves or any combination of curved sides and straight sides. For example, the lighting devices according to embodiments of the invention can have a circular shape, elliptical shape or a trapezoidal shape.

It will be apparent to those skilled in the art that various modifications and variations can be made in the embodiments of the invention without departing from the spirit or scope of the invention. Thus, it is intended that embodiments of the invention cover the modifications and variations of this invention provided they come within the scope of the appended claims and their equivalents.

What is claimed is:

1. Light emitting diode lighting, comprising:
a light guide plate having a top surface through which light is emitted, a bottom surface opposite to the top surface and a side surface between the top and bottom surfaces;
a bottom reflector on the bottom surface for reflecting light at the bottom surface back into the light guide plate;
light emitting diodes at the side surface; and
a side reflector on the side surface for reflecting light at the side surface back into the light guide plate,
wherein the side reflector on the side surface has an opening corresponding to at least one of the light emitting diodes.

2. The light emitting diode lighting of claim 1, wherein the side reflector is one of a painted layer and a deposited layer.

3. The light emitting diode lighting of claim 1, wherein the side reflector is adhesively bonded to the side surface.

4. The light emitting diode lighting of claim 1, wherein the opening is an aperture corresponding to a plurality of light emitting diodes.

5. The light emitting diode lighting of claim 1, wherein the side reflector on the side surfaces has apertures respectively corresponding to each of the light emitting diodes.

6. The light emitting diode lighting of claim 1, wherein the light emitting diodes are positioned within the opening.

7. Light emitting diode lighting, comprising:
a light guide plate having a top surface through which light is emitted, a bottom surface opposite to the top surface and side surfaces between the top and bottom surfaces;
a bottom reflector on the bottom surface for reflecting light at the bottom surface back into the light guide plate;
a light strip having a plurality of light emitting diodes at least at one of the side surfaces side reflectors on each of the side surfaces for reflecting light at the side surfaces back into the light guide plate, wherein a side reflector on the at least one of the side surfaces is positioned between the light guide plate and the light strip, and has an opening corresponding to at least one of the plurality of light emitting diodes.

8. The light emitting diode lighting of claim 7, wherein the side reflectors are one of a painted layer and a deposited layer.

9. The light emitting diode lighting of claim 7, wherein the side reflectors are adhesively bonded to the side surfaces.

10. The light emitting diode lighting of claim 7, wherein the opening is an aperture corresponding to the plurality of light emitting diodes.

11. The light emitting diode lighting of claim 7, wherein the side reflector on the one of the side surfaces has apertures respectively corresponding to each of the light emitting diodes in the plurality of light emitting diodes.

12. The light emitting diode lighting of claim 7, wherein the plurality of light emitting diodes are positioned within the opening.

13. The light emitting diode lighting of claim 7, comprising an other plurality of light emitting diodes at an other one of the side surfaces, wherein an other side reflector on the other one of the side surfaces is positioned between the light guide plate and the other plurality of light emitting diodes, and has an other opening corresponding to the other plurality of light emitting diodes.

14. Light emitting diode lighting, comprising:
a light guide plate having a top surface through which light is emitted, a bottom surface opposite to the top surface and side surfaces between the top and bottom surfaces;
a bottom reflector on the bottom surface for reflecting light at the bottom surface back into the light guide plate;
first and second pluralities of light emitting diodes respectively at opposing side surfaces; and
side reflectors on each of the side surfaces for reflecting light at the side surfaces back into the light guide plate, wherein side reflectors at the opposing side surfaces each have at least an opening corresponding to at least one of the first and second pluralities of light emitting diodes.

15. The light emitting diode lighting of claim 14, wherein the side reflectors are one of a painted layer and a deposited layer.

16. The light emitting diode lighting of claim 14, wherein the side reflectors are adhesively bonded to the side surfaces.

17. The light emitting diode lighting of claim 14, wherein each opening is an aperture corresponding to one of the first and second pluralities of light emitting diodes.

18. The light emitting diode lighting of claim 14, wherein each light emitting diode in the first plurality of light emitting diodes is positioned at a corresponding aperture in one of the side reflectors at the opposing side surfaces and each light emitting diode in the second plurality of light emitting diodes is positioned at a corresponding aperture in an other one of the side reflectors at the opposing side surfaces.

19. The light emitting diode lighting of claim 14, wherein the first and second pluralities of light emitting diodes are positioned within openings of side reflectors.

20. The light emitting diode lighting of claim 14, comprising a third plurality of light emitting diodes at an other one of the side surfaces, wherein an other side reflector on the other one of the side surfaces is positioned between the light guide plate and the third plurality of light emitting diodes, and has an other opening corresponding to the third plurality of light emitting diodes
